(19) United States
(12) Patent Application Publication
(10) Pub. No.: US 2005/0179675 A1
(43) Pub. Date: Aug. 18, 2005

(54) Pixel fault masking

(75) Inventors: Gerben Johan Hekstra, Eindhoven (NL); Michiel Adriaanszoon Klompenhouwer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILLIPS ELECTONICS N.C.

(21) Appl. No.: 10/515,753

(22) PCT Filed: Apr. 29, 2002
(86) PCT No.: PCT/IB03/01871

(30) Foreign Application Priority Data
May 27, 2002 (EP) 0277065.7

(51) Int. Cl. G09G 5/00; G09G 5/10

(52) U.S. Cl. 345/204

(57) ABSTRACT

A method for masking faulty sub-pixels in a display having a plurality of pixels formed of a number of sub-pixels, wherein at least one pixel in said display is faulty and comprises at least one sub-pixel having a defect. The method comprises obtaining (S2) a set (15) of sub-pixel values (2, 3, 4) for generating desired perceptive characteristics for said pixel and determining (S3) a modified set (16) of sub-pixel values (2′, 3′, 4′) for generating modified perceptive characteristics for said pixel. This modified set of sub-pixel values is based on information (14) regarding the sub-pixel defect so as to be implementable in the display, and has values chosen to reduce an error perceived by a user. The modified values are then implemented (S4) in the display. The display is preferably of the kind where each pixel comprises a set of primary sub-pixels each emitting a primary color and at least one additional, redundant sub-pixel for emitting an additional color, such as a RGBW display.

The present invention relates to pixel fault masking in a display having a plurality of pixels formed of a number of sub-pixels. Aspects of the invention include a method, a control unit, and a display device.

In conventional display systems, a number of sub-pixels, normally three for the red green and blue (RGB) primaries, make up a pixel. Mixing appropriate levels of each of the primaries makes up the desired color and intensity of a pixel. Recently, displays are emerging that make use of an additional, redundant sub-pixel in addition to the primary colors, such as a white sub-pixel (RGBW). The redundant sub-pixel can be used for enhancing the luminance of the display, preferably without altering the chrominance at all. An example of this is described in WO 0137249, hereby incorporated by reference.

When manufacturing displays such as liquid crystal displays, an important factor for determining the unit cost is the yield, i.e., the number of defect displays produced for every functioning display. A display is defect if it contains faulty pixels, i.e., pixels that for some reason will not function appropriately, typically resulting from a defect sub-pixel.

Normally, a certain number of faulty pixels can be accepted for a specific class of displays, and displays having a number of faulty pixels exceeding this number are scrapped. However, even a single faulty sub-pixel can be a source of irritation, especially once it is spotted.

To eliminate the occurrence of faulty pixels is very expensive, if at all possible. Further, the difficulty of producing a perfect display is related to the number of pixels and the size of the display, and the problem with faulty pixels is therefore likely to increase as resolution and panel size increase.

Therefore, it would be desirable to mask the effect of faulty pixels, hence reducing the risk of spotting them. This would also permit increasing the number of accepted faulty pixels per display, and thereby reduce the number of scrapped displays. This increases the yield, and is beneficial in many aspects: more displays can be sold, less waste material is generated in the process, and the production cost per display is reduced.

In camera systems, fault masking already exists, and has been implemented in commercially available chips. According to this technique, the surrounding of a defect sub-pixel is used to compute its expected value, thus masking the fault. This technique is, however, not applicable to displays.

Another approach is error diffusion, i.e., distributing the error in approximating a certain value over a set of neighbouring pixels. This is by itself not a suitable technique for fault masking, since the error to be distributed typically is too large, e.g., a sub-pixel stuck at level zero. In fact, the visibility of the fault appears increase due to the sharpening effect that occurs in the diffusion. Thus, so far, there is no available technique for masking of defect sub-pixels.

An object of the present invention is to provide adequate masking of faulty pixels in a display.

Another object is to provide a satisfying quality of the displayed image characteristics as perceived by a user.

According to a first aspect of the present invention, these objects are achieved with a method according to the preamble of claim 1, further comprising obtaining, for each faulty pixel, information of said defect sub-pixel, obtaining a set of sub-pixel values for generating desired perceptive characteristics for said pixel, determining a modified set of sub-pixel values for generating modified perceptive characteristics for said pixel, said modified set of sub-pixel values being based on said information so as to be implementable in the display, said modified set (16) of sub-pixel values being such as to reduce an error perceived by a user resulting from a difference between said desired perceptive characteristics and said modified perceptive characteristics, and implementing said modified set of sub-pixel values in the display.

By taking the sub-pixel defect into consideration, the set of sub-pixel values is thus recalculated into a modified set, in order to minimize the error perceived by the user. Typical perceived characteristics include luminance (brightness) and chrominance (color).

It is important to realize that this does not necessarily mean that the error in terms of absolute sub-pixel values is minimized. Minimizing the error in terms of absolute sub-pixel values would minimize the chrominance error, without taking luminance into consideration. In order to obtain a smaller perceived error, an adjustment might therefore be made to better maintain desired luminance.

A requirement for effective fault masking is that the intended sub-pixel values can be adjusted both up and down to result in the actual sub-pixel values. In a case where all sub-pixels are used in normal operation, some remaining capacity of these sub-pixels is preferably reserved, in order to enable optimal fault masking according to the invention.

By this method, sub-pixel defects become practically invisible to the human visual system, and will hence no longer be a source of irritation. By allowing more defects in a display, the yield can be improved drastically, with the advantages mentioned above.

Considering that the number of faulty pixels is low compared to the total number of pixels, the method will be low-cost, even in a case when the implemented method is computationally complex. If the fault masking is kept relatively simple, then the overhead, compared to normal pixel processing, is extremely low.

The information about faulty pixels can be obtained from a predefined list storing location and details of each faulty pixel. It may also be advantageous, as an alternative or in combination with the list, to automatically detect sub-pixel defects. This eliminates the need for storing information about defects at the time of production, and also makes the fault masking adaptive to the occurrence of new faults. This in turn makes it possible to enhance the useful lifetime of displays for which defects appear over time (e.g., PLED, but also LCD).

The set of sub-pixel values can be obtained from a display memory, and the modified set of sub-pixel values can be returned to the memory. This offers an efficient way to interface with a conventional display driver.

The determination can include solving an approximation problem of constrained least square (CLS) type.

The display is preferably of the kind where each pixel comprises a set of primary sub-pixels each emitting a primary color and at least one additional, redundant sub-pixel for emitting an additional color. The primary colors are chosen so as to enable generation of any given color by combining them in adequate ratios. The most conventional combination of primaries is of course red, green and blue (RGB). The additional color can be chosen so as to include contributions from each of the primary colors. The example mentioned above was white (RGBW), but also other colors, such as cyan, magenta, or yellow can be useful. With more than three sub-pixels, it is also possible with an altogether different set of colors, making division into primaries and non-primaries superfluous.

The redundant sub-pixel can be shared by several pixels, for example by two pixels. This reduces the total number of additional sub-pixels, making the display less expensive.

The set of sub-pixel values and the modified set of sub-pixel values can each comprise values for sub-pixels adjacent to said defect sub-pixel. The sets are preferably related to the sub-pixels of a specific pixel, but may well be related to other neighborhoods of sub-pixels, if this is found advantageous.

The original set of sub-pixel preferably comprises values for the primary color sub-pixels of a pixel. By only comprising these values, in a redundant sub-pixel type display, a certain “headroom” is guaranteed by the additional intensity that can be provided by activating the additional, redundant color sub-pixel. The modified set of sub-pixel values then also comprises values for any such redundant sub-pixel of the pixel.

Note that there is a trade-off between maximum luminance (no headroom reserved) and maximum fault masking performance (headroom available). This trade off can be very useful used in situation where produced displays are graded according to the number of faults and to their application (monitor, TV, video, still images, etc.) and market (professional or consumer). In expensive, essentially fault free displays, no headroom needs to be reserved, while in less expensive, faulty displays, headroom should be reserved in order to allow for the fault masking according to the present invention.

Grading of displays according to the number of defects/headroom in the described way can also work for non-redundant displays (e.g., conventional RGB).

The method can further comprise compensating faulty pixels by error diffusion. While inefficient for large errors such as sub-pixel stuck at zero, error diffusion may be advantageous for small errors remaining after fault masking according to the above method. This may be particularly advantageous in a case of limited headroom as described above.

The method according to the invention is preferably implemented in a display in which sub-pixels can be addressed accurately (matrix displays). Examples of such displays are active matrix LCD and PLEDs.

According to a second aspect of the present invention, the above objects are achieved with a control unit for a display having a plurality of pixels formed of a number of sub-pixels, the control unit comprising means for obtaining, for each faulty pixel, information of said defect sub-pixel, means for obtaining a set of sub-pixel values for generating desired perceptive characteristics for the faulty pixel, means for determining a modified set of sub-pixel values for generating actual perceptive characteristics for said faulty pixel, said modified set of sub-pixel values being based on information regarding said sub-pixel defect so as to be implementable in the display, said modified set of sub-pixel values being such as to reduce an error perceived by a user resulting from a difference between said desired perceptive characteristics and said actual visual characteristics being such as to reduce an error perceived by a user, and means for implementing said modified set of sub-pixel values in the display.

The control unit can further comprise a memory for storing information about sub-pixel defects. This provides the determining means with necessary information for determining the modified set of values.

Alternatively, or in combination with the memory, the control unit comprises means for automatically detecting sub-pixel defects. With a higher yield mentioned above, it becomes feasible to assemble the control unit on the panel before the (currently manual) panel test. Combined with active detection of defects in these drivers, a self-test can be performed, enabling more automation in testing, repair, and grading.

The control unit can of course be implemented in a display device, and such a display is considered a third aspect of the present invention.

These and other aspects will be better understood by the following description of a currently preferred embodiment, with reference to the appended drawings.

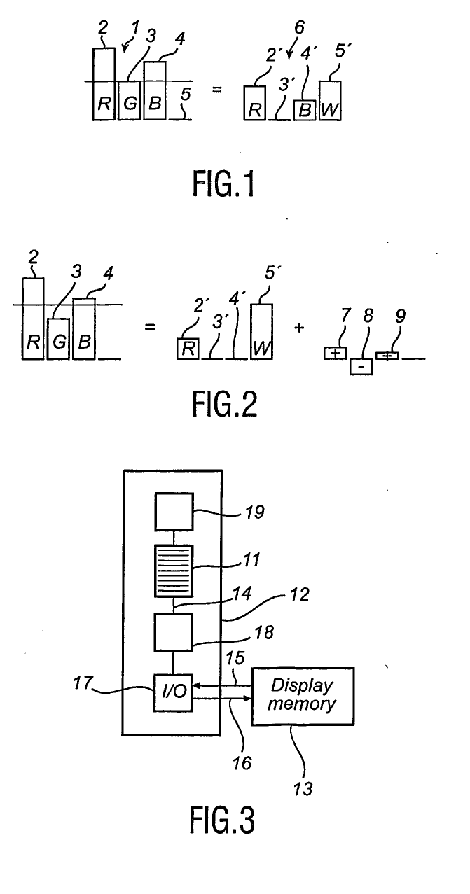

FIG. 1 illustrates alternative ways to generate the same perceptive characteristics from a pixel having redundant sub-pixels.

FIG. 2 illustrates masking of a defect sub-pixel according to an embodiment of the invention.

FIG. 3 is a schematic block diagram of a control unit according to an embodiment of the invention communicating with a display driver.

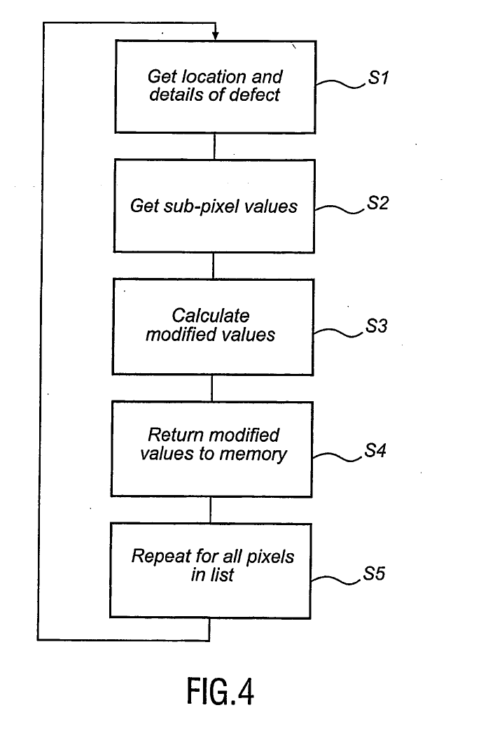

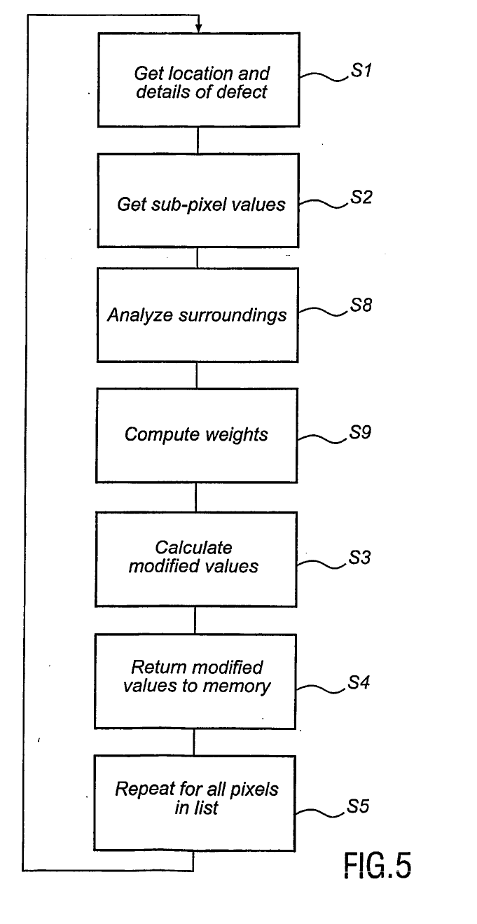

FIG. 4 is a flow chart of a method according to a first embodiment of the invention.

FIG. 5 is a flow chart of a method according to a second embodiment of the invention.

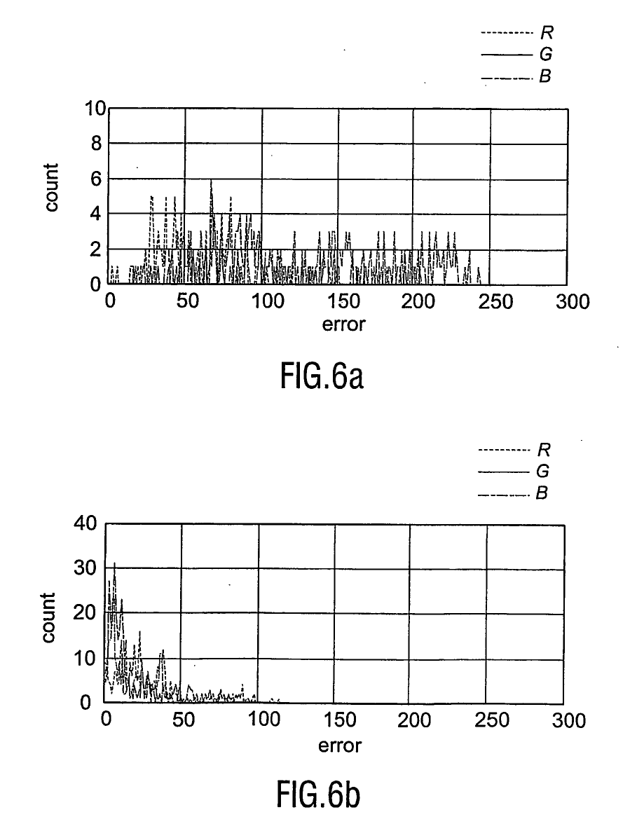

FIG. 6a-6b illustrate remaining errors after masking.

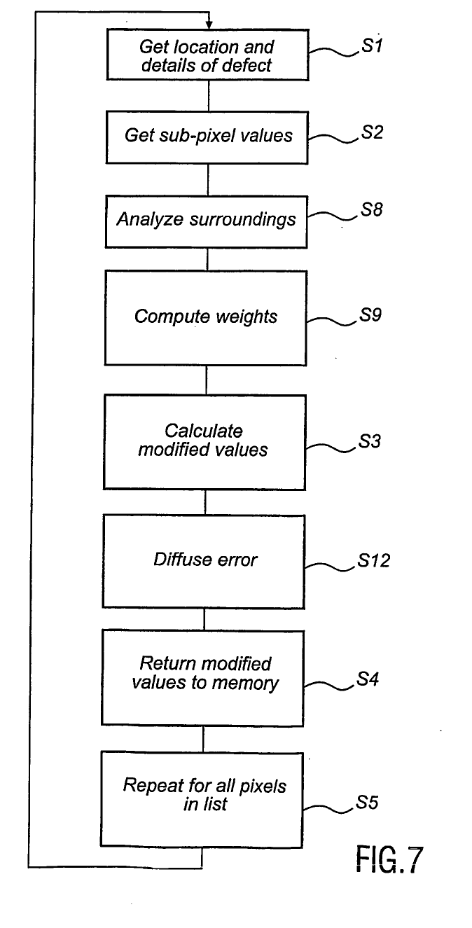

FIG. 7 is a flow chart of a method according to a third embodiment of the invention.

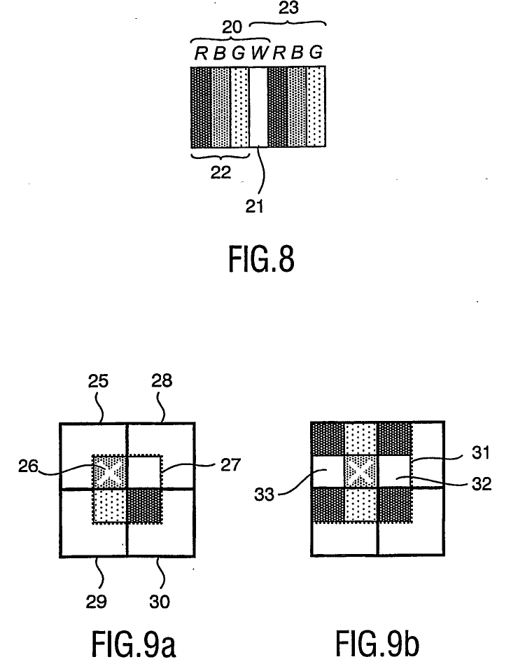

FIG. 8 illustrates several pixels sharing the same redundant sub-pixel.

FIG. 9a-9b illustrate several alternative pixel neighborhoods.

The following description is related to a display having several pixels, each made up of a number of individually addressable sub-pixels. Examples of such displays are active matrix liquid crystal displays and PLED displays.

Further, a preferred embodiment relates to a display in which the sub-pixels of a pixel are redundant, i.e. can emit at least one additional color apart from the required primary colors. As mentioned above, an RGBW pixel structure is an example of such a set of redundant sub-pixels, having a white sub-pixel in addition to the primary red, green and blue sub-pixels.

With redundant sub-pixels there are multiple ways to drive the individual sub-pixels to achieve the same chrominance and luminance. An example of this is shown graphically in FIG. 1, where the same color and intensity is achieved on both sides in this figure. On the left hand side is indicated a set 1 of sub pixel values red 2, green 3, blue 4 and white 5. The white sub-pixel 5 is set to zero. On the right hand side is illustrated a set 6 of different values red 2′, green 3′, blue 4′ and white 5′. In this case, the white level 5′ is taken as the minimum of the RGB levels 2, 3, 4, being the green level 3. This level is then subtracted from all RGB levels 2, 3, 4, as shown on the right, with the result that the green sub-pixel level 3′ is set to zero.

With this approach, both sets 1, 6 of pixel values result in the same color and intensity. Note that, in this example, if the green sub-pixel would have been defect (stuck-at-off), it could have been compensated without introducing any error.

The principles of the invention are illustrated with reference to FIG. 2, where identical objects have been given the same references as in FIG. 1. In this case, the pixel is defect, and more precisely the sub-pixel for the blue primary is stuck-at-off. Therefore, the desired set of sub-pixel values 2, 3, 4, indicated on the left hand side of FIG. 2, can not be implemented by the display panel. According to the present invention, the intensity values for the remaining sub-pixels (in this case red, green and white) are modified to compensate for the absent blue contribution, so that the perceived error is minimized, or at least reduced.

As an example, such error minimization can be include that the overall luminance of the error is close to zero, while the chrominance of the error is as close as possible to white. There is a preference to approximate the luminance better than the chrominance, since the human visual system (HVS) is known to be more sensitive to luminance differences, and to have a lower resolution for chrominance.

Returning to FIG. 2, the modified sub-pixel values 2′, 3′, 4′, 5′ are shown on the right hand side, together with the error 7, 8, 9. As can be seen, the white sub-pixel 5′ has been activated, and manages to compensate for the majority of the lacking blue contribution. At the same time, the white sub-pixel 5′ contributes in the red and green areas, and these sub-pixel values have to be reduced. As the desired blue value 3 exceeds the desired green value 2, there will be an error in the green color, or in the blue color, or in both. In the illustrated case, an error is introduced in the green color 8, and a small error 9 also remains in the blue color.

If the absolute error in sub-pixel values were to be minimized, the red color could be modified so as to avoid error in the red. However, due to the fact that it is the perceived characteristics, resulting from the sub-pixel values, that are minimized, an error 8 is introduced also in the red color in order to minimize the luminance error.

The general problem can be described in the following, mathematical, way:

Let \vec{m} be a vector of the desired pixel value, defined in an n-dimensional linear space, such as the CIE 1931 XYZ color space or the Lu ‘v’ luminance/chrominance space. Let \vec{p} be the vector of the values (normalized, and display gamma independent) for the k sub-pixels, and let M be an n×k matrix to transform a point in the k-dimensional sub-pixel space to the n-dimensional perceptive space. The j^{th} column in M is the location of the j^{th} sub-pixel in the perceptive space.

The approximation problem is expressed in matrix form as:
\vec{m}=M·\vec{p}+\vec{ε},
where \vec{ε} is the error in approximation, defined in the perceptive space. The equation is written out in full as:

$$[ \begin{matrix}{m}_{1} \\ {m}_{2} \\ ⋮ \\ {m}_{n}\end{matrix} ] = [ \begin{matrix}{M}_{11} & {M}_{12} & … & {M}_{1 k} \\ {M}_{21} & {M}_{22} & & {M}_{2 k} \\ ⋮ & & ⋰ & ⋮ \\ {M}_{n1} & {M}_{n2} & … & {M}_{nk}\end{matrix} ] \cdot [ \begin{matrix}{p}_{1} \\ {p}_{2} \\ ⋮ \\ {p}_{k}\end{matrix} ] + [ \begin{matrix}{ɛ}_{1} \\ {ɛ}_{2} \\ ⋮ \\ {ɛ}_{n}\end{matrix} ]$$

Any solution to the approximation problem must satisfy the constraints:
0≦pᵢ≦1, iεG
pᵢ=fᵢ, iεF,
where G and F are the sets of indices of the functioning (G) and faulty (F) sub-pixels within a given pixel respectively. Each of the faulty primaries can be stuck at a given, fixed level fᵢ. Our objective is to minimize the approximation error \vec{ε}, for which we propose to minimize the L₂-norm of \vec{ε}, which can be expressed:

$$min {\sum }_{i} {( {ɛ}_{i} )}^{2} .$$

The approximation error can be weighed, so to minimize

$${\sum }_{i} {( {w}_{i} {ɛ}_{i} )}^{2} .$$

This enables prioritizing perceptive measures, such as luminance over chrominance. The weighing is achieved by left-multiplying all terms in the equation with the weighting matrix W, given by:

$$W = [ \begin{matrix}{w}_{1} & & & \\ & {w}_{2} & & \\ & & ⋰ & \\ & & & {w}_{n}\end{matrix} ] .$$

The weighted problem is then given by:
W·\vec{m}=W·M·\vec{p}+W·\vec{ε}

The weights wᵢ of the approximation error can be made adaptive to the image content around the defect. For example, the surroundings of the faulty pixel can be analyzed to detect smooth or textured luminance, smooth or textured chrominance, or edges. Based on this, the weights can be adapted to minimize the perceived error, given the surroundings.

The entire problem as stated above is a constrained least squares (CLS) problem, which can readily be solved by known techniques, using for example Optimization Toolbox for use with Matlab, distributed by MathWorks. The complexity of solving the problem is relatively low, since the dimensions of the matrix Mare quite small (typically k=4 and n=2). Moreover, since the matrix M is known, and the same for all pixels, dedicated and faster solvers can be developed.

Typically, there are tens of defects in a display having millions of sub-pixels. As the above problem only needs to be solved for the defect pixels, there is relatively much time available to solve the approximation problem. This makes it feasible to use general purpose, low power and low-complexity hardware to solve the approximation problem.

The proposed scheme has been simulated and has been found to work exceptionally well. These tests were performed for a number of still images, with an emulated RGBW display with 500 defect sub-pixels.

A schematic illustration of a control unit 12 implementing a fault masking process according to the invention implemented together with a display system 13 is shown in the flow chart in FIG. 3. The control unit 12 comprises a memory 11 storing a list of information about faulty pixels. It is here assumed that any defects of the display in question are specified, both regarding position and type. Typically this could be achieved by letting the list 11 include the location of the faulty pixels, the faulty sub-pixels within that pixel, and the details of each faulty sub-pixel. The details of the sub-pixel defect can consist of an intensity level at which the sub-pixel is stuck. Typically the level is zero, i.e., the sub-pixel does not emit any light (is black). The list of faults can preferably be generated beforehand, for example during production of the display. However, it would be advantageous if the display automatically could detect which sub-pixels are defect and what the characteristic of the defect is. This would ensure an updated and correct list 11 at all times. For this purpose, the control unit can be provided with a module 19 for automatically detecting defects in the sub-pixels of the display. Such a module 19 can be connected to the memory 11, and can be arranged to update the list if needed.

Further, an input/output module 17 is arranged to communicate with the display system 13. The display system in FIG. 3 is only represented by a display memory 13, while other components are left out for the sake of clarity. In contact with the memory 11 and the I/O-module is a module 18 for solving the approximation problem described above.

Such a control unit 12 for performing the steps in the flow charts of FIGS. 4, 5 and 7 can be implemented by any combination of software and/or hardware components, and be incorporated in the circuitry of a conventional display driver.

A flow chart of the process performed by the control unit 12 in FIG. 3 is illustrated in FIG. 4.

In step SI, program control obtains, from the list 11 of defect pixels, the location and details 14 of a defect, i.e., the faulty sub-pixel(s) and the stuck-at level(s). Then, in step S2, a set of desired sub-pixel values 15 is obtained from display memory 13, e.g., from a frame memory, pixel stream or likewise. In step S3, the set of desired sub-pixel values 15 and the sub-pixel defect 14 are used as inputs to an optimization, which delivers an approximation in the form of a modified set of sub-pixel values 16. As described above, this modified set may include additional sub-pixel values, e.g., for a white sub-pixel. In step S4 the modified set of values 16 is then returned to the display memory 13, or communicated directly to the display driver (not shown). The above steps S1-S4 are repeated for all pixel defects in the list 11 and for each picture frame, by a program loop effected in step S5.

The fault masking can be run out of synch with the regular pixel processing, or be part of the same processing flow.

An alternative to the flow chart in FIG. 4 is given in FIG. 5. In this case, after the desired sub pixel values have been obtained in step S2, the surroundings of the defect pixel are analyzed in step S8. This can be accomplished by obtaining the pixel values for adjacent pixels from the display memory 13. Then, in step S9, weights are computed, and then used as input to the optimization in step S3. Such weights can be used to favor selected perceptive characteristics. The weights can be adaptive, in order to enable adjustment to changing image characteristics.

FIG. 6a-b show a typical distribution of errors in both the image with defects (FIG. 6a), and the image with fault masking (FIG. 6b). Clearly the large errors are eliminated, and only errors with smaller values remain, which makes the approximation error eligible for error diffusion.

The scheme for this is known, and consists of adapting the intensity of pixels adjacent to a faulty pixel, thereby compensating the error. All known methods perform some form of a 1-D scanning over the image, resulting in a directed error diffusion (to the bottom-right). If error diffusion is implemented after fault masking according to the described method, the error can be distributed equally in all possible directions.

Therefore, a novel ring diffusion scheme is proposed. Any residual error is first distributed over the immediate surrounding in all dimensions (a first ring of pixels). Preference can be given to correct overall luminance errors, possibly at the cost of introducing additional chrominance errors. If there is still a luminance error after this, pixels forming the next “ring” can be used to correct this error, and so on within reasonable limits. By giving preference to first correcting the luminance, and then the chrominance error, minimal visibility of the defect is expected.

A flow chart of the method including the error diffusion is illustrated in FIG. 7, with error diffusion performed in step S 12, after the modified values have been calculated in step S3.

Note that it is not necessary that each pixel has its own individual redundant sub-pixel. To limit the redundancy, a redundant sub-pixel 21 can be shared over a group of surrounding pixels, as illustrated in FIG. 8 for the case of one white sub-pixel shared by two pixels 22 and 23. The shared redundant sub-pixel 21 is then used by the control unit 12 to mask a defect in any one of these pixels 22, 23.

Further, the optimization need not be restricted to the sub-pixels within the tight boundaries of a single pixel. Any set of close neighboring sub-pixels could suffice, as illustrated in FIG. 9a-b. In FIG. 9a, instead of modifying the sub-pixel values for the pixel 25 comprising the defect sub-pixel 26, a group of sub-pixels 27 is defined comprising one sub-pixel from each of four neighboring pixels 25, 28, 29, 30. In FIG. 9b, the selected group of sub-pixels 31 comprises nine sub-pixels, including two white 32, 33. It can even be preferred to test several different neighborhoods (groups of sub-pixels) in order to determine which one provides the best masking. For example, as mentioned above, a sub-pixel stuck at zero can be completely corrected if the defect sub-pixel has the lowest value in the group (see FIG. 1). It can therefore be useful to investigate whether a group of sub-pixels can be defined wherein the defect sub-pixel has the lowest value.

Theoretically, the invention is applicable also to displays with non-redundant sub-pixels (standard RGB). Trial experiments have shown improvement, albeit not as much as for redundant sub-pixels. The performance could be improved by including more surrounding sub-pixels in the optimization, as mentioned above.

In parts of the above description, only one faulty sub-pixel has been assumed. In order to achieve satisfying fault masking, it can then be preferred to have multiple redundant sub-pixels.

A number of additional variations to the described embodiments are possible within the scope of the appended claims. For example, other computational schemes than the proposed CLS optimization are possible, as long as they try to minimize the perceived error in luminance and chrominance. The optimization problem can also be extended to include the distance to surrounding sub-pixels. This could be used to favor sub-pixels which are spatially close to the defect, and so to minimize any perceived spatial errors. Such an extension could be implemented by adding a single vector of the distances dᵢ as an extra row in the matrix M.

Also, in the above description, the distance between pixel defects has been assumed large enough that only independent defects have to be considered. However, this is not a restriction of the invention, which could be adapted to handle dependent defects.

1. Method for masking faulty sub-pixels in a display having a plurality of pixels formed of a number of sub-pixels, wherein at least one pixel in said display is faulty and comprises at least one sub-pixel having a defect, said method being characterized by
obtaining, for each faulty pixel, information of said defect sub-pixel,
obtaining a set of sub-pixel values for generating desired perceptive characteristics for said pixel,
determining a modified set of sub-pixel values for generating modified perceptive characteristics for said pixel, said modified set of sub-pixel values being based on said information so as to be implementable in the display, said modified set of sub-pixel values being chosen to reduce an error perceived by a user resulting from a difference between said desired perceptive characteristics and said modified perceptive characteristics, and
implementing said modified set of sub-pixel values in the display.

2. Method according to claim 1, wherein said information is obtained from a predefined list storing location and details of each faulty pixel.

3. Method according to claim 1 or 2, further comprising automatically detecting sub-pixel defects.

4. Method according to claim 1, wherein said set of sub-pixel values is obtained from a display memory, and said modified set of sub-pixel values is returned to said memory.

5. Method according to claim 1, wherein said determination includes solving an approximation problem of constrained least square type.

6. Method according to claim 1, wherein each pixel comprises a set of primary sub-pixels each emitting a primary color and at least one additional sub-pixel each emitting an additional color.

7. Method according to claim 6, wherein said additional sub-pixel is shared by several pixels.

8. Method according to claim 1, wherein said set of sub-pixel values and said modified set of sub-pixel values each comprise values for sub-pixels adjacent to said defect sub-pixel.

9. Method according to claim 8, wherein said set of sub-pixel values comprises values for the primary sub-pixels of a pixel.

10. Method according to claim 8, wherein said modified set of sub-pixel values also comprises values for any additional sub-pixel of the pixel.

11. Method according to claim 1, further comprising compensating faulty pixels by error diffusion.

12. Method according to claim 1, wherein the display is of matrix type.

13. Control unit for a display having a plurality of pixels formed of a number of sub-pixels, wherein at least one pixel in said display is faulty and comprises at least one sub-pixel having a defect,
characterized by
means for obtaining, for each faulty pixel, information of said defect sub-pixel,
means for obtaining a set of sub-pixel values for generating desired perceptive characteristics for said faulty pixel,
means for determining a modified set of sub-pixel values for generating actual perceptive characteristics for said faulty pixel, said modified set of sub-pixel values being based on said information so as to be implementable in the display, said modified set of sub-pixel values being such as to reduce an error perceived by a user resulting from a difference between said desired perceptive characteristics and said actual visual characteristics, and
means for implementing said modified set of sub-pixel values in the display.

14. Control unit for a display according to claim 13, further comprising a memory for storing information about sub-pixel defects.

15. Control unit for a display according to claim 13, further comprising means for automatically detecting sub-pixel defects.

16. Control unit according to claim 13, said control unit being adapted to control a display wherein each pixel comprises a set of primary sub-pixels each emitting a primary color and at least one additional sub-pixel each emitting an additional color.

17. Control unit according to claim 16, wherein said additional sub-pixel is shared by several pixels.

18. Display device comprising a control unit according to claim 13.

19. Display according to claim 18, said device being of matrix type.
